(19) United States
(12) Patent Application Publication
(10) Pub. No.: US 2026/0358158 A1
(43) Pub. Date: Nov. 12, 2026

(54) AC LINE NOISE FILTER FOR AN ELECTROMAGNETIC FLOWMETER

(71) Applicant: Micro Motion, Inc., Boulder, CO (US)

(72) Inventors: Scot Ronald Foss, Eden Prairie, MN (US); Jared James Dreier, Chaska, MN (US)

(21) Appl. No.: 19/421,405

(22) Filed: Dec. 16, 2025

Related U.S. Application Data
(60) Provisional application No. 63/804,024, filed on May 12, 2025.

(51) Int. Cl. G01F 1/60

(52) U.S. Cl. CPC G01F 1/60

(57) ABSTRACT

A magnetic flowmeter for sensing flow of a process fluid includes a flow tube configured to receive the flow of process fluid therethrough. A magnetic coil is arranged to apply an alternating magnetic field to the flow of process fluid through the flow tube, the alternating magnetic field having a period. At least one electrode senses an EMF induced in the flow of process fluid due to the applied magnetic field and provides a sense signal output. The sense signal includes AC line noise. An AC line noise filter samples a portion of the sense signal during a sample window which has a duration related to a period of the AC line noise to thereby filter the AC line noise. Flow measurement circuitry measures flow rate based on the sampled portion of the sense signal.

### CROSS-REFERENCE TO RELATED APPLICATION

The present application is based on and claims the benefit of U.S. provisional patent application Ser. No. 63/804,024, filed May 12, 2025, the content of which is hereby incorporated by reference in its entirety.

### BACKGROUND

Magnetic flowmeters (or mag meters) measure flow by application of Faraday's Law, an electromagnetic effect. The magnetic flowmeter energizes one or more coils by passing an excitation current through field windings which generates a magnetic field across an electrically isolated, conductive process flow. An electromotive force (EMF) is generated by the flowing process fluid crossing through the magnetic field; this induced voltage (potential) both across the fluid and with respect to the rest of the process fluid can readily be measured by one or more conductive electrodes that contact the flowing process fluid. Alternatively, some magnetic flowmeters employ capacitive coupling between the electrodes and the process fluids such that the potential can be measured without direct electrical connection to the process. The volumetric flow is proportional to the flow velocity and the cross-sectional area of the flowtube. As the flow velocity is directly proportional to the electrode voltage potential (EV), the electrode voltage potential (EV) is directly proportional to the induced magnetic field strength (B), and the induced magnetic field strength is assumed to be proportional to the applied magnetic field (H), which is directly linked to the magnitude of the excitation current, a direct correlation is provided between measured electrode voltage potential and indicated volumetric flow.

Magnetic flowmeters are useful in a variety of conductive and semi-conductive fluid flow measurement environments. In particular, the flow of water-based fluids, ionic solutions and other conducting fluids can all be measured using magnetic flowmeters. Thus, magnetic flowmeters can be found in water treatment facilities, beverage and hygienic food production, chemical processing, high purity pharmaceutical manufacturing, as well as hazardous and corrosive processing facilities. Magnetic flowmeters are often employed in the hydrocarbon fuel industry which sometimes employs hydraulic fracturing techniques using abrasive and corrosive slurries.

Magnetic flowmeters are crucial for accurate fluid flow measurement. However, they can be highly susceptible to AC line noise. This interference can affect the small electrical signals on the sense electrodes used to measure flow rate. This is especially true in environments with poor grounding, such as sandy soil or inadequate infrastructure. The lack of proper grounding can lead to unstable and imprecise measurements.

### SUMMARY

A magnetic flowmeter for sensing a flow of a process fluid includes a flow tube configured to receive the flow of process fluid therethrough. A magnetic coil is arranged to apply an alternating magnetic field to the flow of process fluid through the flow tube, the alternating magnetic field having a period. At least one electrode senses an EMF induced in the flow of process fluid due to the applied magnetic field and provides a sense signal output. The sense signal includes AC line noise. An AC line noise filter samples a portion of the sense signal based on an AC line noise frequency. Flow measurement circuitry measures flow rate based on the sampled portion of the sense signal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view showing a process control system including a magnetic flowmeter.

FIG. 2 is a block diagram of a magnetic flowmeter with which embodiments of the present invention are particularly applicable.

FIG. 3 is a graph of steady flow in feet/second in a particular embodiment of a magnetic flowmeter having AC line noise present.

FIG. 4 is a signal analysis graph of an electrode sensor showing electrode voltage in a particular embodiment of a magnetic flowmeter having AC line noise present.

FIG. 5 is a frequency analysis graph of the electrode sensor of FIG. 2 showing the frequency with AC line noise present including even and odd harmonics in a particular embodiment of a magnetic flowmeter.

FIG. 6 is a frequency response graph of a particular embodiment of a magnetic flowmeter having an AC line noise filter.

FIG. 7 is a flow diagram of AC line noise frequency detection and mitigation in a particular embodiment of a magnetic flowmeter having AC line noise present.

FIG. 8 is a flow comparison graph of steady flow with AC line noise present comparing flow measurements of a magnetic flowmeter without an AC line noise filter and flow of a magnetic flowmeter of the present embodiment with an AC line noise filter.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

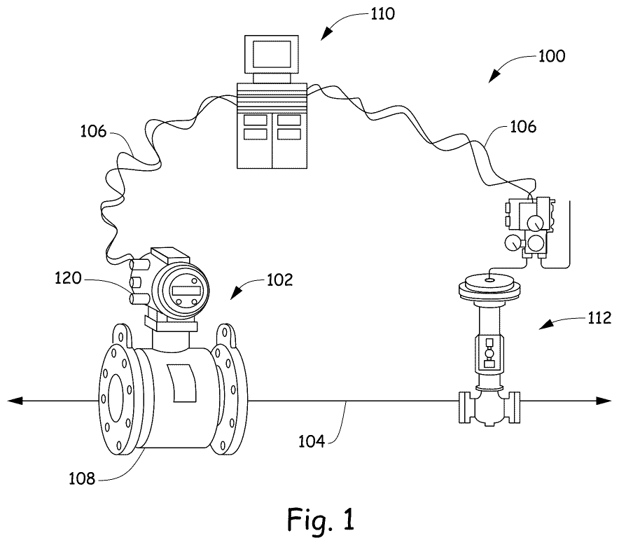

FIG. 1 illustrates a typical industrial process environment 100 for magnetic flowmeter 102. Magnetic flowmeter 102 is coupled to process piping, illustrated diagrammatically at line 104 that also couples to control valve 112. Magnetic flowmeter 102 is configured to provide a flow rate output related to process fluid flow through piping 104 in a process. Examples of such process fluids includes slurries and liquids in chemical, pulp, pharmaceutical and other fluid processing plants.

Magnetic flowmeter 102 includes electronics housing 120 connected to flowtube 108. Magnetic flowmeter 102 outputs are configured for transmission over long distances to a controller or indicator via process communication connection 106. In typical processing plants, communication connection 106 can be either a digital communication protocol, or an analog communication signal. The same or additional process information can be made available via wireless communication, pulse width or frequency output, discrete input/outputs (DI/DO) or other communication techniques. System controller 110 can optionally display flow information for a human operator as well as provide control signals over process communication connection 106 in order to control the process using control valves, such as valve 112.

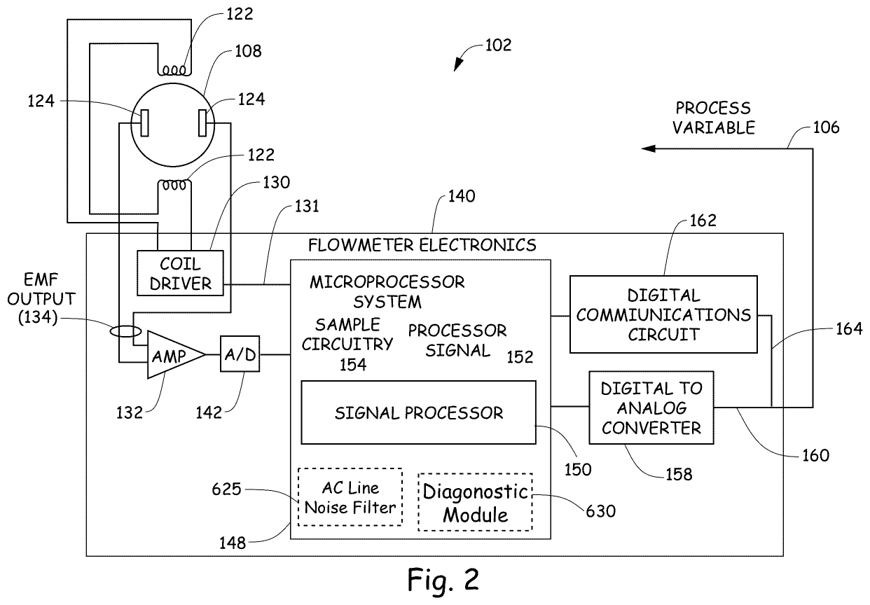

FIG. 2 is a block diagram of a magnetic flowmeter with which embodiments of the present invention are particularly applicable. Magnetic flowmeter 102 measures a flow of conductive process fluid through flowtube assembly 108. Coils 122 are configured to apply an external magnetic field in the fluid flow in response to an applied excitation current from coil driver 130. EMF sensors (electrodes) 124 electrically couple to the fluid flow and provide an EMF signal output 134 to amplifier 132 related to an EMF generated in the fluid flow due to the applied magnetic field, fluid velocity, and noise. Analog-to-digital converter 142 provides a digitized EMF signal to microprocessor system 148. A signal processor 150 is implemented in microprocessor system 148 of flowmeter electronics 140 which couples to the EMF output 134 to provide an output 152 related to fluid velocity. Sample circuitry 154 may be implemented in microprocessor system 148 to sample portions of the sense signal output 134.

Microprocessor system 148 calculates fluid flow velocity through flowtube 108 in accordance with a relationship between the EMF output 134 and flow velocity as described in an application of Faraday's Law:

$$V = \frac{E}{kBD}$$

Where E can be the signal output 152 which is related to the EMF output 134, V is the velocity of the fluid, D is the diameter of the flowtube 108, B is the strength of the induced magnetic field in the fluid, and k is a constant of proportionality. A nuance of this application of Faraday's law is that the excitation current, I, is considered directly proportional to B, the induced magnetic field. Coil driver 130 provides both the excitation current and a measurement of either the induced magnetic field or excitation current, which is important for the accuracy of the velocity measurement. The measurement of the excitation current is provided through line 131. Microprocessor system 148 uses velocity and measured magnetic field or coil current to calculate flow of the process fluid in accordance with known techniques. A digital-to-analog converter 158 coupled to microprocessor system 148 and generates an analog transmitter output 160 for coupling to communication bus 106. A digital communication circuit 162 generates a digital transmitter output 164. The analog output 160 and/or the digital output 164 can be coupled to process controllers or monitors as desired.

Magnetic flowmeters and other field devices may, in some configurations, utilize a ground connection to the conductive process fluid to provide for accurate process measurements. If a proper ground connection is not present, the voltage signal sensed at the electrodes 124 of the magnetic flowmeter 102 may experience line noise generated by the AC power used to power the surrounding process environment 100. In one example, such line noise signals may be within a frequency range of approximately 50 Hz to 60 Hz. It should be understood that the line noise may be influenced by ambient process noise and vibrations, by nearby radio frequency signals, by other sources of noise, or any combination thereof.

Magnetic flowmeters are susceptible to such AC line noise interference due to the very small electrical signals on the sense electrodes generated due to the applied magnetic field and the flow of process fluid. Proper grounding is often difficult or impossible in some environments such as those with sandy soil or poor infrastructure. In one aspect, the present invention solves the grounding problem by rejecting the AC line noise, resulting in a more stable and precise flow measurement. This technique is particularly useful to provide an advanced magnetic flowmeter with high sensitivity and stability.

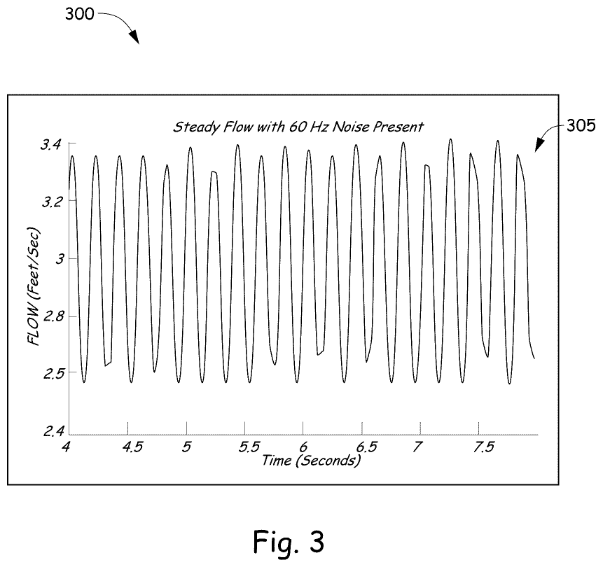

FIG. 3 is a graph 300 illustrating the steady flow measurement of a process fluid calibrated in feet/second versus time with AC line noise present for a particular embodiment of a magnetic flowmeter having a poor ground connection. As shown in graph 300, the flow measurement 305 oscillates rapidly over time due to the presence of AC line noise in the sense signal 134. The AC line noise frequency interacts with coil drive frequency seen in the sense voltage to create a beat frequency, or oscillation, in the flow measurement 305. This oscillation in the flow measurement can lead to unstable and imprecise measurement that can make it difficult to control the flow loop. FIG. 3 illustrates a steady flow with 60 Hz AC line noise present, however it is to be understood that AC line noise may be present in other frequencies.

Further, AC line noise in the field at a process installation is rarely a pure sinusoidal signal and can include both even and odd harmonics. The addition of harmonics makes it difficult to filter out the AC line noise from the measurement signal in previous filters. In an example of a flowmeter with 60 Hz AC line noise present without the present invention, an AC line noise filter would require multiple high order band pass filters to remove the 60 Hz noise and its harmonics (120 Hz, 180 Hz, . . . ). Removing AC line noise and its harmonics using this technique is typically not feasible in most magnetic flowmeters due to processing power limitations.

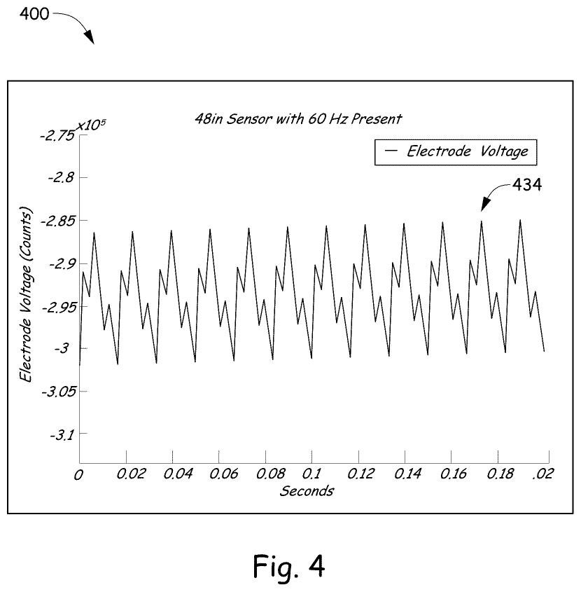

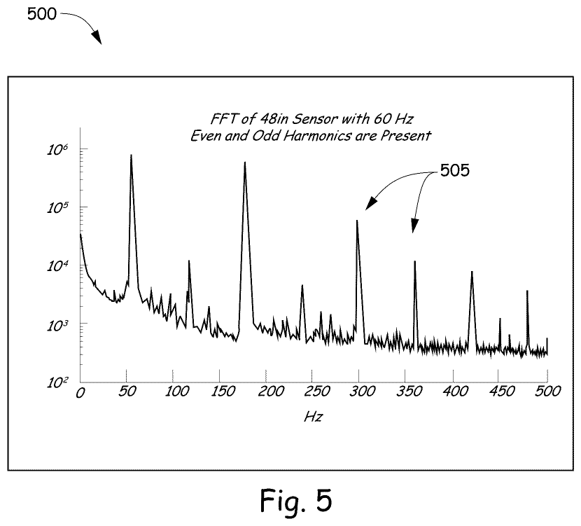

FIGS. 4 and 5 illustrate signal and frequency analysis from a magnetic flowmeter sensor in a particular embodiment of a field sample. In this example, a 48-inch diameter sensor (flow tube) is used which includes 60 Hz AC line noise present in the sense signal. FIG. 4 is a signal analysis graph 400 of an electrode sensor, such as electrode 124, showing electrode voltage (EV) 434 with 60 Hz AC line noise present in a particular embodiment of a magnetic flowmeter having a poor ground connection. As seen in FIG. 4, the sense signal 434 oscillates over time due to the presence of 60 Hz AC line noise.

FIG. 5 is a frequency analysis graph 500 of an electrode sensor, such as the electrode sensor used in FIG. 4. Graph 500 provides the FFT (Fast Fourier transform) of the sensor signal which shows the magnitude of each frequency 505 present in a sample. In this example, graph 500 shows the amplitude of different frequencies 505 with 60 Hz AC line noise and its even and odd harmonics present in a particular embodiment of a magnetic flowmeter having a poor ground connection. For example, graph 500 illustrates multiple spikes at different frequencies due to even and odd harmonics of AC line noise that are present in the sense signal output.

Referring to FIG. 2, in a particular embodiment, microprocessor 148 further includes an AC line noise filter 625. AC line noise filter 625 may include the sample circuitry 154 which is configured to sample a portion of the sensed signal output 134 from the electrodes 124. The filter 625 is configured to filter an AC line noise frequency by sampling the signal output based on the AC line noise frequency, such as the 60 Hz AC line noise illustrated in FIGS. 3-5. The line noise filter 625 targets the removal of a specific AC line noise frequency, such as 50 Hz or 60 Hz, and can further remove the related AC line noise harmonics, such as shown in FIG. 5. It is to be understood that line noise filter 625 may be implemented within the signal processor 150, as a separate sample circuitry within the flowmeter electronics 140, or both without departing from the scope of the invention.

Previous magnetic flowmeters typically sample the trailing end of the electrode square wave to measure the height that corresponds to the flow rate. For example, previous magnetic flowmeters may sample have sampled the trailing twenty percent of the sense signal waveform. In these previous flowmeters, sampling the trailing portion of the waveform allows the electrode signal to stabilize so that it more accurately represents flow rate but this does not remove line noise interference.

In one aspect, the solution of the present invention for the AC line noise problem is to adjust the amount of the coil waveform that is sampled and averaged. The line noise filter 625 samples a portion of the sense signal 134, such as by using sample circuitry 154. This sampled portion has a duration related to a period of the AC line noise, to thereby filter the AC line noise. The AC line noise filter 625 operates by averaging the electrode signal over a sample period that has a duration that is the period of the AC line noise frequency.

In one aspect, the present invention selects the percent of the square wave that is averaged to based upon the period of the line noise frequency. In a specific configuration, the present invention adjusts the portion of the sensed waveform that is averaged to be the period of the line noise frequency. This can be done by the microprocessor controlling the sample circuitry. In this configuration, the AC line noise filter is thereby configured to sample a portion of the sensed signal output based on an AC line noise frequency to reject the AC line noise frequency and all its harmonics.

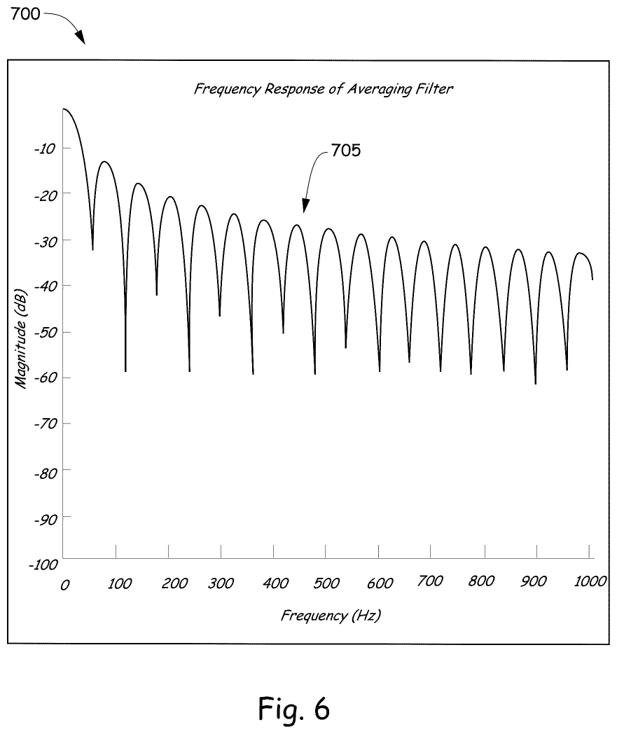

FIG. 6 is a frequency response graph 700 of the magnitude, in dB, versus the frequency, in Hz, of a particular embodiment of a magnetic flowmeter having an AC line noise filter 625. FIG. 6 illustrates the magnitude of each frequency 705 present in a sample when the main frequency and the harmonics are rejected by the AC line noise filter 625. In this example, the filter 625 reduces the standard deviation in the measured flow rate by 22 times in comparison to traditional flow measurement techniques.

In another embodiment, the AC line noise filter 625 can be configured to provide automatic line noise frequency detection and mitigation. Magnetic flowmeter 602 may further include a diagnostic module 630 implemented using microprocessor 148 shown in FIG. 2, or be incorporated within flowmeter electronics 140, such as through amplifier 132 or the A/D converter 142, which provides the digitized EMF signal to microprocessor system 148. Diagnostic module 630 is configured to provide grounding and wiring diagnostics that measure the energy in the electrode signal at specific frequencies. Module 630 may be located within microprocessor system 148 as illustrated in FIG. 2 and implemented in programming instructions. The diagnostic module 630 may be configured to measure the signal strength of the sensed signal output 134 of the electrodes 124 at different frequencies. For example, the signal strength may be measured at 50 Hz and 60 Hz. The flowmeter 102 can then use these signal strength values to determine which AC line noise frequency will be filtered. In one embodiment, the diagnostic module 630 determines the AC line noise frequency to filter based on the largest measured signal strength at the different frequencies. It is to be understood that diagnostic module 630 may be implemented within the microprocessor 148, such as within signal processor 150, or as a separate module within the flowmeter electronics 140, or both without departing from the scope of the invention.

The AC line noise filter 625 may then be set to the appropriate frequency to optimize the AC line noise rejection. For example, if the diagnostic module 630 measures the signal strength at 50 Hz and 60 Hz, and if the signal strength at 50 Hz is larger than the signal strength at 60 Hz, the filter 625 may then be set to the 50 Hz period by the diagnostic module 630.

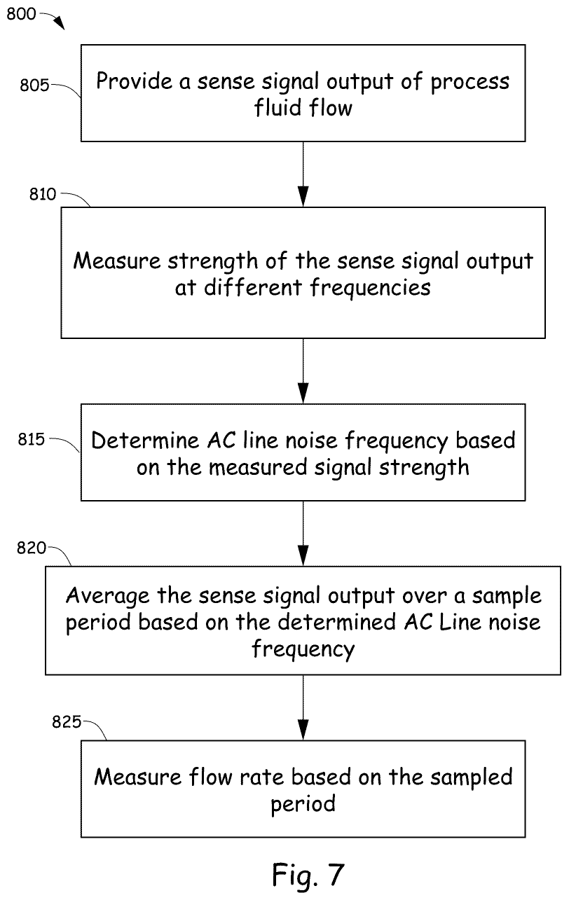

FIG. 7 is a flow diagram 800 of AC line noise frequency detection and mitigation in a particular embodiment of a magnetic flowmeter having AC line noise present. At 805, a sense signal output of a process fluid flow is provided, such as the signal output of the signal analysis graph 400, which includes 60 Hz AC line noise, as shown in FIG. 4. At 810, the strength of the sense signal output is measured at different frequencies. For example, the strength of the sense signal output may be measured at 50 Hz or 60 Hz. At 815, the AC line noise frequency is determined based on the measured signal strength. For example, if the 60 Hz signal strength is greater than the 50 Hz signal strength, then the AC line noise frequency is determined to be 60 Hz.

At 820 the sense signal output is averaged over a sample period based on the determined AC line noise frequency. For example, if the AC line noise frequency is determined to be 60 Hz, then the averaging time would be set to the 60 Hz period. At 825, the flow rate of the process fluid is measured based on the sampled period. For example, the measured flow rate will use the sampled 60 Hz period to filter out the 60 Hz AC line noise, such as is present in the graph 400 of FIG. 4.

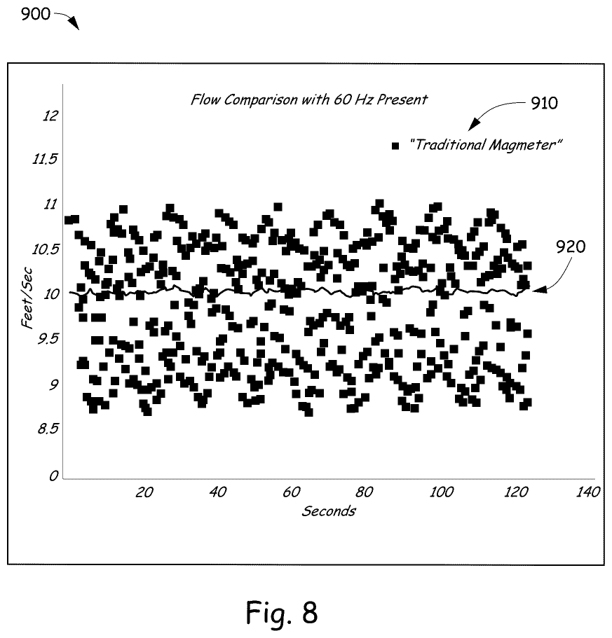

FIG. 8 is a flow comparison graph 900 of a steady process fluid flow with 60 Hz AC line noise present. Graph 900 illustrates the flow measurement of a magnetic flowmeter without the AC line noise being filtered as points 910 and the flow of a magnetic flowmeter of the present embodiment with an AC line noise filter optimized for 60 Hz rejection as line 920. Points 910 represent the measured flow rate of a traditional magnetic flowmeter with AC line noise interference. In comparison, line 920 illustrates the flow measurement with the AC line noise filter mitigating the AC line noise interference by averaging the electrode signal over a period corresponding to the AC line noise frequency.

In various aspects, the invention includes a magnetic flowmeter for sensing flow of a process fluid that includes at least one electrode to provide a sense signal output of the flow. The magnetic flowmeter may include a diagnostic module configured to determine an AC line noise frequency in the sense signal output. An AC line noise filter is configured to filter the determined AC line noise from the sensed signal output by sampling the sense signal output based on the determined AC line noise frequency. Flow measurement circuitry within the flowmeter is configured to measure the flow rate of the process fluid based on the sampled portion of the sense signal. The AC line noise present in a signal output is thus filtered, providing a more stable and precise flow measurement. In one example, the diagnostic module measures the signal strength of the sense signal output at a frequency of 50 Hz and 60 Hz to determine the proper frequency to filter.

Although the present invention has been described with reference to preferred embodiments, workers skilled in the art will recognize that changes may be made in form and detail without departing from the spirit and scope of the invention.

What is claimed is:

1. A magnetic flowmeter for sensing flow of a process fluid, comprising:
a flow tube configured to receive the flow of process fluid therethrough;
a magnetic coil arranged to apply an alternating magnetic field to the flow of process fluid through the flow tube, the alternating magnetic field having a period;
at least one electrode arranged to sense an EMF induced in the flow of process fluid due to the applied magnetic field and provide a sense signal output, wherein the sense signal includes AC line noise;
an AC line noise filter configured to sample a portion of the sensed signal output based on an AC line noise frequency; and
flow measurement circuitry configured to measure flow rate based on the sampled portion of the sense signal.

2. The flowmeter of claim 1, further comprising a diagnostic module configured to measure signal strength of the sensed signal output at different frequencies.

3. The flowmeter of claim 2, wherein the diagnostic module determines the AC line noise frequency based on the largest measured signal strength at the different frequencies.

4. The flowmeter of claim 2, wherein the diagnostic module measures signal strength of the sense signal output at 50 Hz and 60 Hz.

5. The flowmeter of claim 1, wherein the AC line noise filter includes sample circuitry to sample the portion of the sensed signal output.

6. The flowmeter of claim 5, wherein the AC line noise filter removes at least one of 50 Hz 60 Hz AC line noise.

7. The flowmeter of claim 1, wherein the AC line noise filter removes harmonics of the AC line noise frequency.

8. The flow meter of claim 1, wherein the AC line noise filter samples and averages the sense signal output over a sample period which corresponds to the AC line noise frequency.

9. The flowmeter of claim 8, wherein the averaged sample of the sense signal has a duration that is the period of the AC line noise frequency to thereby filter the AC line noise.

10. The flowmeter of claim 1, wherein the AC line noise frequency is at least one of 50 Hz and 60 Hz.

11. A method of measuring a flow of a process fluid, comprising:
providing a sensed signal output of an induced EMF in the flow of the process fluid with at least one electrode;
measuring the strength of the sensed signal output at different frequencies with a diagnostic module;
determining an AC line noise frequency based on the measured signal strength;
averaging the sense signal output over a sample period which corresponds to the determined AC line noise frequency with sample circuitry;
measuring the flow rate of the process fluid based on the sampled period of the sense signal output with flow measurement circuitry.

12. The method of claim 11, wherein the determined AC line noise frequency is based on the largest measured signal strength.

13. The method of claim 12, wherein the strength of the sensed signal output is measured at least one of 50 Hz and 60 Hz.

14. The method of claim 13, wherein the averaging time is set to at least one of a 50 Hz period and a 60 Hz period.

15. A magnetic flowmeter for sensing flow of a process fluid, comprising:
at least one electrode configured to provide a sense signal output of the flow of process fluid;
a diagnostic module configured to determine an AC line noise frequency in the sense signal output;
an AC line noise filter configured to filter AC line noise from the sensed signal output by sampling the sense signal output based on the determined AC line noise frequency; and
flow measurement circuitry configured to measure flow rate based on the sampled portion of the sense signal.

16. The magnetic flowmeter of claim 15, wherein the diagnostic module measures a signal strength of the sense signal output at 50 Hz and 60 Hz to determine an AC line noise frequency.

17. The magnetic flowmeter of claim 15, wherein the AC line noise filter removes at least one of 50 Hz and 60 Hz AC line noise.

18. The magnetic flowmeter of claim 15, wherein the AC line noise filter averages the sense signal output over a sample period which is the period of the determined AC line noise frequency.

19. The magnetic flowmeter of claim 18, wherein the sample period is set to at least one of a 50 Hz period and a 60 Hz period.

20. The magnetic flowmeter of claim 15, wherein the flow measurement circuitry measures the flow rate based on the sampled portion of the sense signal output at at least one of a 50 Hz period and a 60 Hz period.
